(19) United States
(12) Patent Application Publication
(10) Pub. No.: US 2014/0226108 A1
(43) Pub. Date: Aug. 14, 2014

(54) LIQUID CRYSTAL DISPLAY DEVICE

(71) Applicant: JAPAN DISPLAY INC., TOKYO (JP)

(72) Inventors: Shimon ITAKURA, Tokyo (JP); Takayuki OTA, Tokyo (JP)

(73) Assignee: JAPAN DISPLAY INC., TOKYO (JP)

(21) Appl. No.: 14/174,864

(22) Filed: Feb. 7, 2014

(30) Foreign Application Priority Data
Feb. 12, 2013 (JP) 2013-024036

(51) Int. Cl. F21V 8/00

(52) U.S. Cl. CPC G02B 6/0001
USPC 349/65

(57) ABSTRACT

A liquid crystal display device includes a liquid crystal display panel formed by a pair of transparent substrates facing each other with a liquid crystal layer therebetween, and a backlight device mounted on a back surface of the liquid crystal display panel. The backlight device includes a light source in which multiple light emitting elements are arranged in parallel on a surface of a substrate, and a light guide plate for converting light from the light source that is provided in the periphery of the light guide plate, into planar light (backlight beam) and emitting the planar light. The light guide plate has a concave groove portion along the periphery. At least the light emitting elements are inserted into the groove portion to integrate the light guide plate and the light source into a single unit. A bottom of the groove portion formed at a position close to an irradiation area of the planar light than a side surface of the light guide plate, or/and a side wall surface of the groove portion is/are incident surface(s) of the light from the light emitting elements.

### CLAIM OF PRIORITY

The present application claims priority from Japanese Patent Application JP 2013-024036 filed on Feb. 12, 2013, the content of which is hereby incorporated by reference into this application.

### BACKGROUND

The present invention relates to a liquid crystal display device, and more particularly to a backlight device mounted on the back surface of a liquid crystal display panel to emit planar light.

In a conventional side light type backlight device, a light source in which multiple light emitting diodes LED are mounted on a surface of a substrate (for example, aluminum substrate) PC is provided on a side surface of a light guide plate LG. For example, as shown in FIG. 9, the back surface of the substrate PC is attached to the inner wall surface of a frame member FL. At this time, the light emitting diodes LED mounted on the surface of the substrate PC are disposed to face the side surface of the light guide plate LG. In other words, the light source and the light guide plate LG are separately provided to irradiate the side surface of the light guide plate LG with the light from the light emitting diodes LED. In this case, the light emitted from the light emitting diode LED is incident from the side surface of the light guide plate LG, and is converted into planar light in the light guide plate LG. Then, the light passing through multiple optical sheets OS is emitted as a backlight beam.

Meanwhile, as a liquid crystal display device in which multiple light emitting diodes are fixed to the side surface of a light guide plate, for example, a planar light emitting device and a display device including the planar light emitting device are described in Japanese Patent No. 4369698. In the technology described in Japanese Patent No. 4369698, the light emitting diodes are bonded and fixed to the side surface of the light guide plate with cationic curable epoxy resin. In this configuration, light emitted from the light emitting diodes is directly incident from the side surface of the light guide plate through the cationic curable epoxy resin.

### SUMMARY OF THE INVENTION

With the recent development of thin liquid crystal display devices, the trend towards using thin backlight devices has accelerated. The thickness of the light guide plate LG is reduced to about 3 mm also in a large liquid crystal display device of 19 inches or more, and further reduction in thickness is required. However, when the thickness of the light guide plate LG is reduced, as shown in FIG. 10, the light from the light emitting diode LED is emitted away from the side surface of the light guide plate LG due to the warpage of the light guide plate LG, the variability in the assembly of the backlight device, and the like. Thus, there is a problem of the variation of the intensity of the light incident on the light guide plate LG.

Another problem is that if the warpage of the light guide plate LG is large, the light emitted away from the side surface of the light guide plate LG is directly incident on the liquid crystal display panel, and this is directly visible to an observer.

Japanese Patent No. 4369698 discloses a technology for fixing the light emitting diode to a side wall of the light guide plate. However, this technology requires additional processes such as application and curing of epoxy resin to fix the light emitting diode to the side surface of the light guide plate LG. Thus, there is concern about the reduction in the productivity. Further, in the configuration described in Japanese Patent No. 4369698, an air layer is not formed between the light emitting diode and the light incident surface (side surface) of the light guide plate. In other words, the gap between the light emitting diode and the light incident surface (side surface) of the light guide plate is filled with cationic curable epoxy resin. Thus, the heat dissipation of the light emitting diode may be reduced and there is also a concern that the light emission efficiency of the light emitting diode may be reduced.

The present invention has been made in view of the above problems, and an object of the present invention is to provide a technology that can suppress the variation of the intensity of the light incident on the side surface of the light guide plate due to warpage of the light guide plate, the variability in the assembly of the light guide plate and the like, even if the thickness of the used light guide plate is thin.

In order to solve the above problems, a liquid crystal display device according to the present invention includes: a liquid crystal display panel formed by a pair of transparent substrates facing each other with a liquid crystal layer therebetween; and a backlight device mounted on a back surface side of the light crystal display panel.

The backlight device includes a light source in which multiple light emitting elements are arranged in parallel on a substrate surface, and a light guide plate for converting light from the light source that is provided in the periphery of the light guide plate, into planar light (backlight beam) and emitting the planar light.

The light guide plate has a concave groove portion along the periphery.

At least the light emitting elements are inserted into the groove portion to integrate the light guide plate and the light source into a single unit.

A bottom of the groove portion formed at a position closer to an irradiation area of the planar light than a side surface of the light guide plate, or/and a side wall surface of the groove portion is/are incident surface(s) of the light from the light emitting elements.

According to the present invention, it is possible to suppress the variation of the intensity of the light incident from the side surface of the light guide plate, due to warpage of the light guide plate, the variability in the assembly and the like, even if the thickness of the used light guide plate is thin. Further, since the variation of the intensity of the light incident from the side of the light guide plate can be suppressed, the thickness of the light guide plate can be further reduced.

Other advantages of the present invention will be apparent from the whole description of the present specification.

### BRIEF DESCRIPTION OF THE DRAWINGS

FIG. 1 is a cross-sectional view showing the general configuration of a liquid crystal display device according to a first embodiment of the present invention;

FIG. 2 is an enlarged cross-sectional view of the portion in which a light emitting diode is mounted in a backlight device according to the first embodiment;

FIGS. 3A and 3B are views showing the detailed configuration of a light guide plate of the backlight device according to the first embodiment;

FIG. 4 is a view of the detailed configuration of the light guide plate of another backlight device according to the first embodiment;

FIG. 5 is a cross-sectional view showing the general configuration of the backlight device in a liquid crystal display device according to a second embodiment of the present invention;

FIG. 6 is a cross-sectional view showing the general configuration of the backlight device in a liquid crystal display device according to a third embodiment of the present invention;

FIG. 7 is a top view showing the general configuration of the backlight device in a liquid crystal display device according to a fourth embodiment of the present invention;

FIG. 8 is a side view showing the general configuration of the backlight device in the liquid crystal display device according to the fourth embodiment of the present invention;

FIG. 9 is a cross-sectional view showing the general configuration of a conventional backlight device; and

FIG. 10 is a cross-sectional view when warpage occurs in the light guide plate of the conventional backlight device.

### DETAILED DESCRIPTION

Hereinafter, embodiments to which the present invention is applied will be described with reference to the accompanying drawings. However, the same components are denoted by the same reference numerals and the repetitive description thereof is omitted in the following description. Further, X, Y, Z shown in the figures represent the X axis, Y axis, and Z axis, respectively.

### First Embodiment

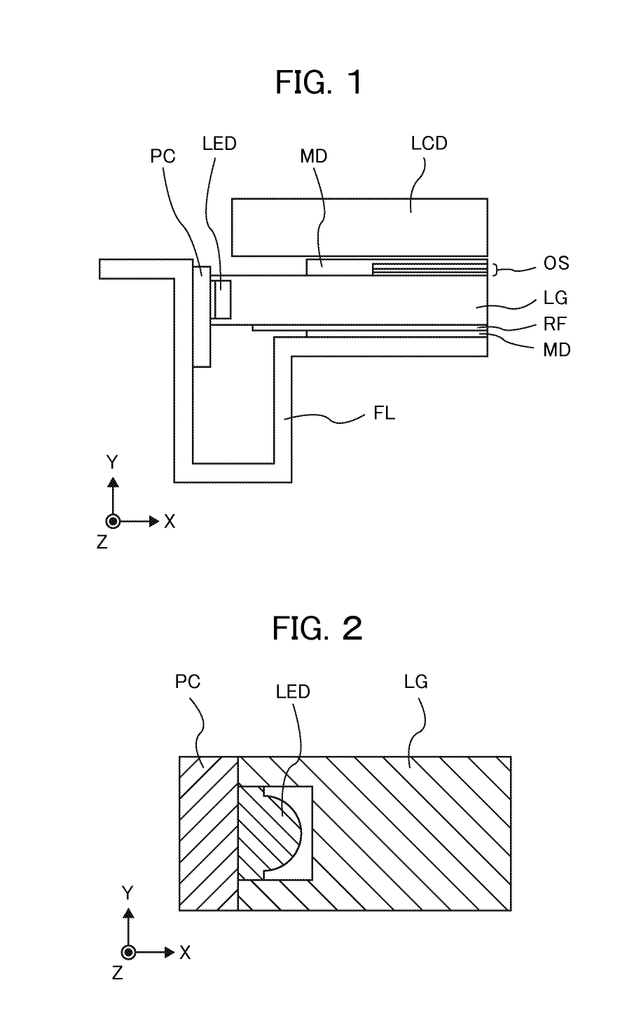

FIG. 1 is a cross-sectional view showing the general configuration of a liquid crystal display device according to a first embodiment of the present invention. Hereinafter, the configuration of the liquid crystal display device according to the first embodiment will be described based on FIG. 1.

As shown in FIG. 1, the liquid crystal display device according to the first embodiment is configured such that a backlight device for emitting planar backlight beam is placed in a metal frame member FL, which is a so-called lower frame, to emit the backlight beam from the back surface side of a known liquid crystal display panel LCD provided on the upper side. Note that it is also possible to provide a frame member called an upper frame on the surface side of the liquid crystal display panel, accordingly, if needed.

The backlight device shown in FIG. 1 is configured such that a light guide plate LG having a rectangular planar shape is positioned at a predetermined position of the metal frame member FL by a resin mold MD. Optical sheets OS, such as a known diffusion plate and a prism sheet, are placed on the surface (one of the planes) of the light guide plate LG, namely, on the side of the planar light emitting surface. The known reflecting plate RF is attached to the back surface (the other plane) of the light guide plate LG. Further, a light source including multiple light emitting diodes (light emitting elements) LED arranged in parallel along a side surface of the light guide plate LG is attached and fixed to the side surface of the light guide plate LG. In this way, a side light type backlight device is formed. Note that the configuration of the light emitting diode LED (light source) fixed to the side surface of the light guide plate LG according to the first embodiment will be described below.

The liquid crystal display panel LCD shown in FIG. 1 is the known liquid crystal display panel in which pixels are arranged in a matrix form in the in-plane direction. As an example, it is possible to use TN and VA type liquid crystal display panels in which a pixel electrode is formed on one transparent substrate of a pair of transparent substrates facing each other with a liquid crystal layer between them, and a common electrode is formed on the other transparent substrate. Alternatively, it is also possible to use a lateral electric field liquid crystal display panel in which a pixel electrode and a common electrode are formed on one transparent substrate of a pair of transparent substrates facing each other with a liquid crystal layer between them.

In the liquid crystal display device according to the first embodiment, the directional light (collected by a lens part) emitted from the light emitting diodes LED is incident on the light guide plate LG, which is converted into planar light by the light guide plate LG and emitted from the emitting surface (the upper surface of the light guide plate LG in FIG. 1). This planar light passing through the optical sheets OS is emitted, as the backlight beam, to the back surface side of the liquid crystal display panel LCD. Note that the light emitting diode LED used for the light emitting element according to the present invention has a lens part as describe in detail below. However, the present invention is not limited to this configuration, and light emitting diode LED without a lens part may be used.

Particularly, in the liquid crystal display device according to the first embodiment, the light emitting diode LED, which is the light emitting source (light emitting element), is fixed to the side surface of the light guide plate LG to be integrated with the light guide plate LG. This makes it possible to suppress the deformation of the light guide plate LG due to the warpage. Further, the light emitting diode LED can follow the warpage of the light guide plate LG, with the deformation according to the stiffness (flexibility) of the substrate on which the light emitted diode LED is mounted as well as the deformation according to the viscosity of the adhesive, which will be described in detail below. Because of this configuration, even if the light guide plate LG is warped, the light emitted from the light emitting diode LED is incident on the light guide plate LG. In addition, since the light source is directly fixed to the light guide plate LG, it is possible to suppress the variation of the intensity of the light incident on the light guide plate LG due to the variability (assembly tolerance) in the assembly of the liquid crystal display device including the backlight device.

As describe above, in the liquid crystal display device according to the first embodiment, the light source and the light guide plate LG are integrally formed in the backlight device, so that the light source (in particular, the substrate on which the light emitting diodes LED are mounted) can suppress the warpage of the light guide plate LG. At the same time, the position of the light source (in particular, the substrate on which the light emitting diodes LED are mounted) moves according to the warpage of the light guide plate LG. In other words, the behavior of the light source and the light guide plate LG approaches, so that it is possible to suppress the variation of the intensity of the light incident on the light guide plate LG, including light leakage, such as when the light from the light emitting diodes LED is not incident on the light guide plate LG but is directly emitted to the liquid crystal display panel LCD and the like. As a result, the thickness of the light guide plate LG can be further reduced, making the backlight device thinner and thus making the liquid crystal display device much thinner.

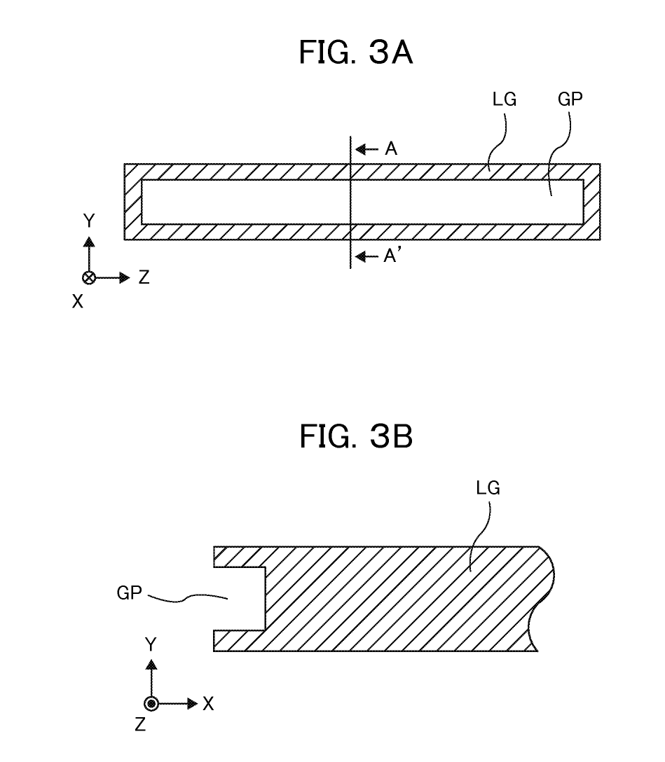

Next, FIG. 2 is an enlarged cross-sectional view of the portion in which the light emitting diode is mounted in the backlight device according the first embodiment. FIGS. 3A and 3B are views showing the detailed configuration of the light guide plate of the backlight device according to the first embodiment. Hereinafter, the backlight device according to the first embodiment will be described in detail based on FIGS. 2, 3A, and 3B. FIG. 3A is a view of the side surface of the light guide plate on which the light sources are mounted, and FIG. 3B is a cross-sectional view taken along A-A′ shown in FIG. 3A. In the following description, the light source includes multiple light emitting diodes LED, which are the light emitting elements, and the substrate on which the light emitting diodes LED are arranged in parallel in the Z direction.

As is apparent from FIG. 3A, the light guide plate LG of the backlight device according to the first embodiment is configured such that a concave groove portion GP is formed on the side surface on which the light source is mounted, namely, the surface on which the light source is mounted. In particular, the groove portion GP is formed so that only the periphery of the side surface remains. In other words, the side wall of the concave groove portion GP is formed along the surface crossing the side surface on which the light source is mounted. As a result, in the configuration of the light guide plate LG according to the first embodiment, as shown in the cross-sectional view in FIG. 3B, one side wall along the surface of the light guide plate LG (the upper side surface in the figure), and the other side wall along the back surface (lower side surface in the figure) are formed as a pair in the area except the two ends in the Z direction of the side surface on which the light source is mounted. Then, a space is formed between the pair of side walls. At this time, the side surface on which the light source is mounted is configured such that the pair of side walls, which extend along the surface and back surface of the light guide plate LG from the bottom of the groove portion GP, projects to the left side (the side on which the light source is mounted on the light guide plate LG). The light guide plate LG with this configuration is generally formed by a known injection molding method and the like, but may also be formed by other molding methods. For example, the groove portion GP is formed by a cutting process after the rectangular light guide plate LG is formed.

The bottom shape of the groove portion GP is a flat shape orthogonal to the depth direction (X direction) of the groove portion GP. Further, the distance from the periphery to the bottom of the groove portion GP is constant. In other words, the normal line direction of the flat bottom of the groove portion GP, and the normal line direction of the side surface of the groove portion GP are the same. Then, the bottom of the groove portion GP is formed such that the side surface of the light guide plate LG on which the groove portion GP is formed and the bottom of the groove portion GP are parallel to each other. Further, the side wall surface of the groove portion GP is parallel to the extending directions (X direction and Z direction) of the light guide plate LG, namely, the in-plain direction of the light guide plate LG. In other words, the thickness of the side wall is constant. Particularly, in the configuration of the first embodiment, as described in detail below, multiple light emitting diodes LED are arranged in one groove portion GP along the side surface of the light guide plate LG. With this configuration, the light guide plate LG according to the first embodiment allows the light from the light emitting diodes LED to be incident on the light guide plate LG effectively and uniformly.

Of the four side walls of the groove portion GP according to the first embodiment, the inner wall surface of the pair of side walls along two side surfaces crossing the side surface on which the light source is mounted, namely, the side wall surface of the left and right side walls in FIG. 3A of the side wall surfaces of the groove portion GP, is parallel to the extending direction of the two side surfaces, namely, the in-plane direction, with the thickness of the side wall surface being constant. This is because it is desirable that the side wall surface is also a flat surface orthogonal to the bottom of the groove portion GP. Particularly, with the configuration in which the four side wall surfaces of the groove portion GP are orthogonal to the bottom of the groove portion GP, it is possible to increase the Y and Z direction widths of the bottom of the groove portion GP, which is the light incident surface on which the light from the light emitting diodes LED is incident. Thus, the light incident efficiency can be improved.

Note that in the light guide plate LG according to the first embodiment, as shown in FIG. 3A, the groove portion GP is formed such that the side walls are formed on the top, bottom, left, and right of the side surface on which the light source is mounted. However, the present invention is not limited to this configuration. For example, the side wall of the groove portion GP can be formed only on the top and bottom of the side surface shown in FIG. 3A. In other words, it is possible to form a groove portion GP passing through in the Z direction from one side surface to the other side surface, with respect to the pair of side surfaces crossing the side surface on which the light source is mounted.

Further, in the configuration of the light guide plate LG according to the first embodiment, the substrate PC on which the light emitting diodes LED are mounted is fixed to the periphery on the side of the opening of the groove portion GP. Thus, the side wall of the groove portion GP should have a predetermined strength. In the configuration of the light guide plate LG according to the first embodiment, the groove portion GP is formed along the side surface shape of the groove portion GP. Thus, the side wall extending in the horizontal direction (the side wall formed on the top and bottom sides in FIG. 3A) is longer than the side wall extending in the vertical direction (the side wall formed on the left and right sides in FIG. 3A). If the thicknesses of the side walls are the same, the strength of the side walls on the left and right sides in the figure is greater than the strength of the other side walls. For this reason, all the side walls shown in FIGS. 3A and 3B have the same thickness, but the present invention is not limited to this configuration. For example, the thickness of the side wall formed on the left and right sides may be smaller than the thickness of the side wall formed on the top and bottom sides in FIG. 3A. In this way, it is possible to further increase the area of the bottom of the groove portion GP which is the light incident surface. As a result, the incident efficiency of the light from the light emitting diodes LED can be further improved.

In the backlight device according to the first embodiment that includes the light guide plate LG having the configuration described above, as shown in FIG. 2, for example, light emitting diodes LED are mounted on the surface of the substrate PC of known aluminum substrate (which is an aluminum-base substrate with aluminum as a base material, with a wiring layer formed on the surface thereof and a protective layer of an insulating member formed on the top of the wiring layer). The substrate PC on which the light emitting diodes LED are mounted is fixed to the side surface of the light guide plate LG. In other words, the substrate PC is fixed to the periphery of the groove portion GP. At this time, the substrate PC and the light guide plate LG are fixed to the surface on which the light emitting diodes LED are mounted. Further, the width in the Y direction of the substrate PC is greater than the width (opening height) in the Y direction of the groove portion GP. Thus, only the light emitting diodes LED mounted on the substrate are arranged in the groove portion GP formed on the side surface of the light guide plate GL. With this arrangement, the side on which the light from the light emitting diodes LED is emitted, namely, the side of the lens part indicated by a curve in the figure, is provided so as to face the bottom of the groove portion GP which is the light incident surface of the light guide plate LG. Note that the light emitting diode LED according to the first embodiment is formed such that the width in the Y direction of the light emitting diode LED is smaller than the width (opening height) in the Y direction of the groove portion GP formed on the side surface of the light guide plate LG. Further, the base part of the light emitting diode LED is greater than the lens part with a curved shape. However, the shape of the light emitting diode LED is not limited to this example and other shapes may be used. For example, it is possible that the base part and the lens portion have the same width.

As described above, in the backlight device according to the first embodiment, one substrate PC is attached to the side surface of the light guide plate LG so that multiple light emitting diodes LED mounted on the substrate PC are arranged in the groove portion GP that is formed on the side surface of the light guide plate LG. With this configuration, the substrate PC can suppress the displacement of the light source and the light guide plate LG at the time of the assembly of the backlight device, and can suppress the warpage due to the heat during use and the manufacturing errors of the light guide plate LG. Thus, it is possible to prevent the displacement of the irradiation position of the light from the light emitting diodes LED, and the like, due to the warpage of the substrate PC. Also, it is possible to suppress the variation of the intensity of the light incident on the light guide plate LG due to the variability in the assembly of the backlight device. In other words, the light guide plate LG and the light source are integrally formed and held by the frame member FL. With this configuration, it is possible to prevent the light from the light emitting diodes LED from being emitted to the outside instead of being emitted to the light incident surface. Further, the substrate PC on which the light emitting diodes LED are mounted is attached and fixed to the side surface of the light guide plate LG. The light guide LG and the light source can be integrated into a single unit, so that the production efficiency of the backlight device can be improved. As a result, there is also an effect of improving the production efficiency of the liquid crystal display device.

Note that the present invention is not limited to the configuration in which the width in the Y direction of the substrate PC is greater than the height of the opening of the groove portion GP in the entire area in the Z direction. For example, an area with the width in the Y direction of the substrate PC being smaller than the height of the opening of the groove portion GP is formed in a portion of the substrate PC extending in the Z direction, or a through hole is formed in the substrate PC, to ventilate the groove portion GP covered by the substrate PC in order to prevent temperature increase in the emission of the light emitting diodes LED.

Further, in the configuration according to the first embodiment, the present invention is applied to a relatively large liquid crystal display device. Thus, the known aluminum substrate with no surge-related problem or other electrical problems and with excellent release of heat generated by the light emitting diodes is used for the substrate PC. However, the substrate PC is not limited to the aluminum substrate. Other substrates such as known CEM-3 substrate and flexible wiring substrate may also be used. In particular, when a substrate, such as a flexible wiring substrate of resin a base material is used as the substrate PC, the substrate PC can suppress the deformation of the light guide plate LG due to the warpage of the light guide plate LG and the like, while deforming itself according to the deformation of the light guide plate LG, by the stiffness and flexibility of the substrate PC itself. As a result, even if the deformation of the light guide plate LG or assembly variability occurs, the position of the light emitting diodes LED can easily follow the deformation of the light guide plate LG (the deformation of the groove portion GP) by the deformation of the substrate PC itself. This can lead to a remarkable effect of further improving the effect of suppressing the variation of the intensity of the light incident on the light guide plate LG, in addition to the effect of using the substrate PC of the aluminum substrate.

Further, in the present embodiment, the width in the Y direction of the light emitting diodes LED placed in the groove portion GP, and the opening height in the Y direction of the groove portion GP are substantially the same. However, the present invention is not limited to this configuration. The width in the Y direction of the light emitting diodes LED may be smaller than the opening height in the Y direction of the groove portion GP. In this case, even if an aluminum substrate with relatively high stiffness is used as the substrate PC, for example, by appropriately selecting the adhesive and adhering position of double-sided tape to bond the substrate PC and the light guide plate LG, the light emitting diodes LED can move within the groove portion GP until the side wall surface of the groove portion GP and the light emitting diodes LED come into contact with each other, even when convex warpage occurs in the light guide plate LG. This allows the light emitting diodes LED to virtually follow the warpage of the light guide plate LG. As a result, it is also possible to obtain the effect of dispersing the stress of the warpage to the light guide plate LG and the substrate PC, while suppressing the variation of the intensity of the light incident on the light guide plate LG.

As described above, in the liquid crystal display device according to the first embodiment, the groove portion GP is formed on the side surface of the light guide plate LG of the backlight device. The bottom of the groove portion GP is the incident surface of the light from the light emitting diodes LED. At least the light emitting diodes LED are inserted into the groove portion GP so that the light emitting diodes LED and the light guide plate LG are integrated into a single unit. Then, the light emitting diodes LED are surrounded by the components of the light guide plate LG. With this configuration, even if the light guide plate LG is warped or the assembly variability occurs, the light emitted from the light emitting diodes LED is incident from the bottom of the groove portion GP which is the light incident surface. At the same time, also the light not incident on the bottom is incident on the light guide plate LG from the side wall surface of the groove portion GP. Thus, it is possible to suppress the variation of the intensity of the light incident on the light guide plate LG.

Further, the light emitting diodes LED are inserted into the groove portion GP to be integrated with the light guide plate LG. Thus, it is possible to prevent the light guide plate LG from being significantly warped, and to prevent light leakage such as when the light emitted from the light emitting diodes LED is directly incident on the liquid crystal display panel LCD outside the liquid guide plate LG. As a result, it is possible to increase the display quality of the liquid crystal display device.

Further, as it is possible to suppress the variation of the intensity of the light incident on the light guide plate LG as well as the light leakage due to the warpage of the light guide plate LG, the thickness of the backlight device can further be reduced. This can lead to a remarkable effect of further reducing the thickness of the liquid crystal display device.

In addition, in the configuration according to the first embodiment, the light emitting diodes LED are fixed to the side surface of the light guide plate LG through the substrate PC on which the light emitting diodes LED are mounted. This makes it possible to significantly reduce the stress applied to a terminal, not shown, in which the light emitting diodes LED and the substrate are electrically connected to each other, when the light guide plate LG is warped. This can lead to a remarkable effect of improving the connection reliability of the joint, namely, the reliability of the backlight device.

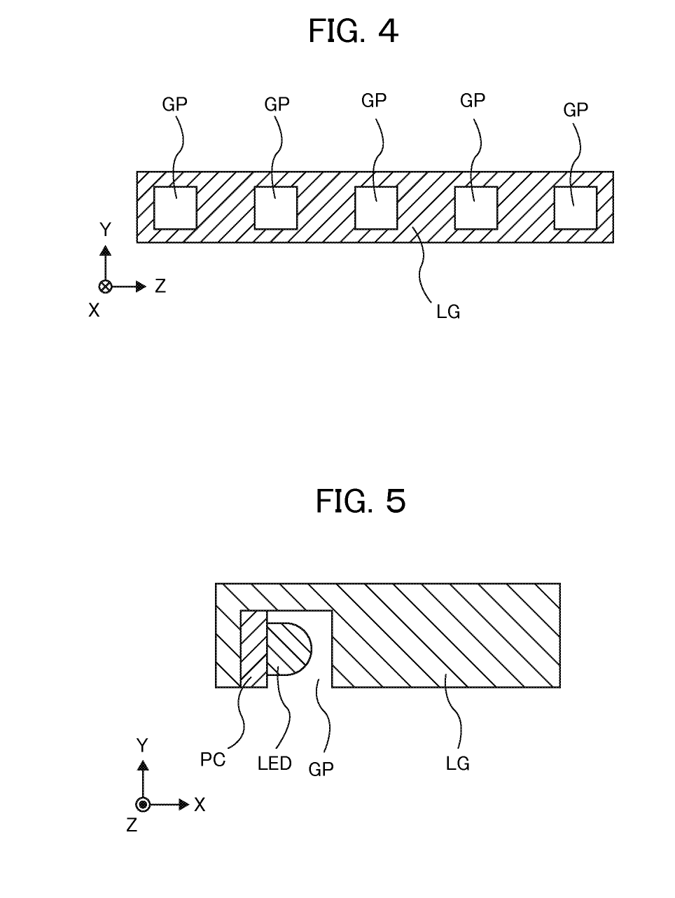

Note that in the liquid crystal display device according to the first embodiment, one groove portion GP is formed so as to extend on the side surface of the light guide plate LG. However, the present invention is not limited to this configuration. For example, as shown in FIG. 4, multiple groove portions GP corresponding to each of the light emitting diodes LED are formed on the side surface of the light guide plate LG. It is also possible that two or more groove portions GP are formed on the side surface of the light guide plate LG and one or more light emitting diodes LED are placed in each groove portion GP. In the configuration of the light guide plate LG shown in FIG. 4, the area between the adjacent groove portions GP (vertical rib) can also be used for the bonding to the substrate PC. Thus, it is possible to increase the reliability of the bonding of the substrate PC and the light guide plate LG.

### Second Embodiment

FIG. 5 is a cross-sectional view showing the general configuration of the backlight device in a liquid crystal display device according to a second embodiment of the present invention. Particularly, FIG. 5 is an enlarged cross-sectional view of the portion on which a light emitting diode is mounted in the backlight device according to the second embodiment, which corresponds to the cross-sectional view in FIG. 2 according to the first embodiment. Note that in the light emitting diode LED according to the second embodiment, the base part and the lens part are the same size. However, the size of the base part and the size of the lens part may be different, similarly to the light emitting diode LED according to the first embodiment.

As shown in FIG. 5, in the backlight device according to the second embodiment, the groove portion GP is formed on the back surface (the lower surface in FIG. 5) of the light guide plate LG. The groove portion GP is formed along the periphery of the light guide plate LG. In other words, the groove portion GP is formed in the area between the planar light irradiation area and the periphery of the light guide plate LG, along the linear periphery, namely, along the shape of the end part of the irradiation area. In the configuration of the light guide plate LG according to the second embodiment, the side wall surface on the side of the planar light irradiation area is the light incident surface, of the side wall surfaces of the groove portion GP. As is apparent from FIG. 5, the emission side of the light emitting diode LED (the side of the lens part) is provided so as to face the light incident surface.

Further, the substrate PC is provided on the back surface side of the light emitting diode LED. The back surface of the substrate PC is fixed to the surface facing the light incident surface with double-sided tape or other adhesive, to supply power for light emission to the light emitting diode LED through the substrate PC. Then, the light emitting diode LED is fixed to a predetermined position within the groove portion GP. At this time, the light from the light emitting diode LED is emitted to match the normal line direction of the surface of the substrate PC on which the light emitting diode LED is mounted. Thus, of the side wall surfaces of the groove portion GP, the side wall surface to which the substrate PC is fixed and the side wall surface which is the light incident surface are parallel to each other. Note that the material for fixing the substrate PC to the light guide plate LG is not limited to the double-sided tape, and other adhesives and fixing materials may also be used.

In the configuration according to the second embodiment, the depth of the groove portion GP is formed corresponding to the width in the Y direction of the substrate PC that is greater than the width in the Y direction of the light emitting diode LED. In other words, the depth of the groove portion is formed so that the substrate PC does not project from the groove portion GP. At this time, in the configuration according to the second embodiment, one end of the substrate PC abuts against the bottom of the grove portion GP, and the other end does not project from the side of the opening of the groove portion GP, namely, from the periphery of the groove portion GP. Then, the light emitting diode LED is provided in the vicinity of the center in the Y direction of the substrate PC.

Further, the width in the X direction (the light emitting direction of the light emitting diode LED) of the groove portion GP is determined by considering the thickness of the fixing member such as double-sided tape, not shown, to fix the substrate PC to the side wall surface of the groove portion GP, the thickness of the substrate PC, the height from the base part of the light emitting diode LED to the lens part, and the gap from the end of the lens part of the light emitting diode LED to the side wall surface. In addition, as the light source is bonded and fixed to the groove portion GP from the side of the opening of the groove portion GP, the width in the X direction of the groove portion GP is determined also by considering the bonding process.

Note that also in the configuration of the light source according to the second embodiment, similarly to the light source according to the first embodiment, multiple light emitting diodes LED are arranged in parallel on one surface of the substrate PC. Thus, the width in the Z direction of the groove portion GP is the same as the width in the Z direction of the groove portion according to the first embodiment. However, also in the configuration of the groove portion GP according to the second embodiment, the groove portion GP can pass through in the Z direction similarly to the groove portion according to the first embodiment.

As described above, in the backlight device according to the second embodiment, the substrate PC on which the light emitting diodes LED are mounted is fixed to the side wall surface of the groove portion GP that is formed on the back surface side of the light guide plate LG. In this way, the light guide plate LG and the light source are integrated into a single unit. Thus, also in the backlight device according to the second embodiment, the same effect as the first embodiment described above can be obtained. Particularly, in the backlight device according to the second embodiment, the groove portion GP is formed on the back surface of the light guide plate LG. This can lead to a remarkable effect of preventing light leakage from the opening of the groove portion GP by a simple configuration of covering the opening of the groove portion GP by extending the reflecting plate RF. In addition, even if the reflecting plate RF is not provided in the opening of the groove portion GP, the light from the opening is emitted to the back surface side of the backlight device, so that this has no influence on the backlight beam.

Note that also in the backlight device according to the second embodiment, multiple light emitting diodes LED are arranged in parallel in one groove portion GP, but the present invention is not limited to this configuration. For example, similarly to the configuration shown in FIG. 4 according to the first embodiment, two or more groove portions GP are formed at locations corresponding to the light emitting diodes LED on the back surface of the light guide plate LG. Then, one or more light emitting diodes LED are placed in each groove portion GP, together with the substrate PC.

### Third Embodiment

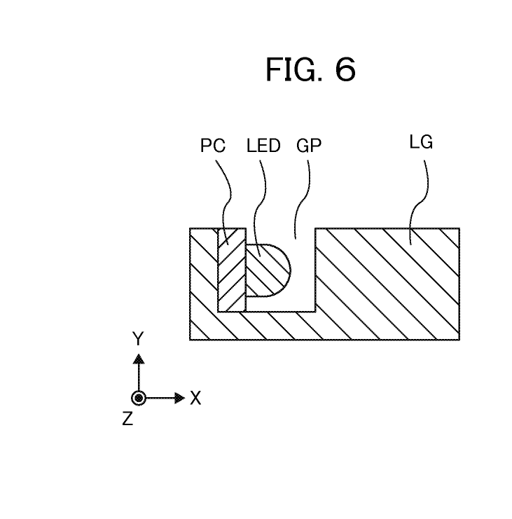

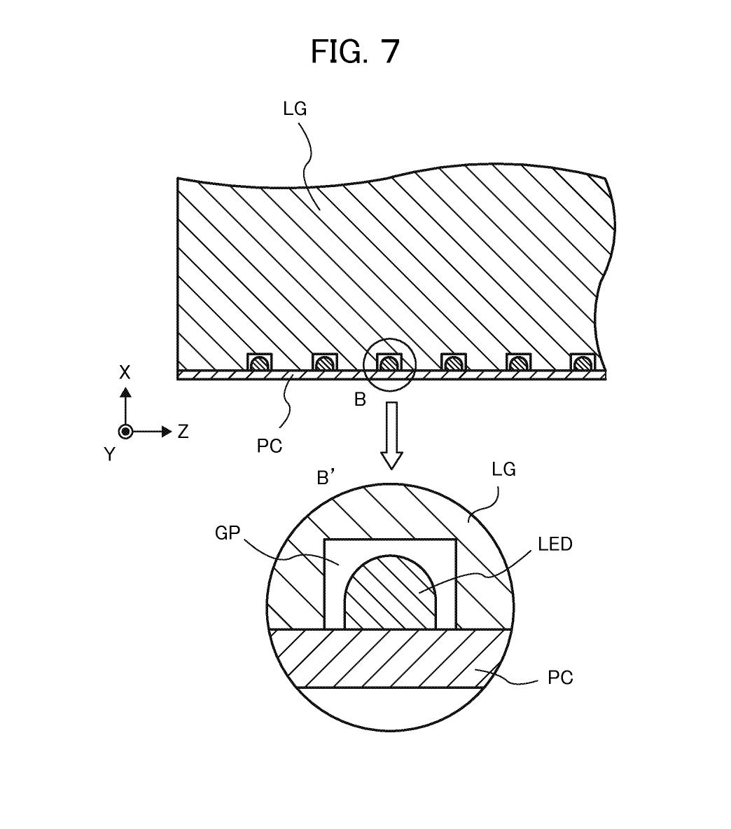

FIG. 6 is a cross-sectional view showing the general configuration of the backlight device in a liquid crystal display device according to a third embodiment of the present invention. In particular, the cross-sectional view corresponds to FIG. 5 according to the second embodiment. The backlight device according to the third embodiment is different only in that the groove portion GP is formed on the surface side of the light guide plate LG, and the other configurations are the same as those in the second embodiment. Thus, the formation position of the groove portion GP will be described in detail below. Note that also in the configuration of the light emitting diode LED according to the third embodiment, similarly to the light emitting diode LED according to the first embodiment, the base part and the lens part may be different in size.

As shown in FIG. 6, in the backlight device according to the third embodiment, the groove portion GP is formed on the surface side of the light guide plate LG, namely, on the surface irradiated with planar light, along the periphery of the light guide plate LG. Thus, also in the configuration of the light guide plate LG according to the third embodiment, the groove portion GP is formed in the area between the planar light irradiation area and the periphery of the light guide plate LG, along the linear periphery, namely, the shape of the edge of the irradiation area.

Further, also in the configuration of the light guide plate LG according to the third embodiment, one side wall surface of the side wall surfaces of the groove portion GP that is close to the irradiation area, is the light incident surface. As is apparent from FIG. 6, the emission side of the light emitting diode LED is provided so as to face the light incident surface. Further, the substrate PC is provided on the back surface side of the light emitting diode LED. The back surface of the substrate PC is fixed to the surface facing the light incident surface with double-sided tape or other adhesives, to supply power for light emission to the light emitting diode LED through the substrate PC. Then, the light emitting diode LED is fixed to a predetermined position in the groove portion GP. Further, the depth of the groove portion GP is formed corresponding to the width in the Y direction of the substrate PC that is greater than the width in the Y direction of the light emitting diode LED. In other words, the depth of the groove portion GP is formed so that the substrate PC does not project from the groove portion GP. Further, the width in the X direction of the groove portion GP is determined by considering the thickness of the fixing material such as double-sided tape, not shown, to fix the substrate PC to the side wall surface of the groove portion GP, the thickness of the substrate PC, the height from the base part to the lens part in the light emitting diode LED, and the gap from the end of the lens part of the light emitting diode LED to the side wall surface. In addition, the fixing process of the substrate PC is also taken into account. Note that also in the configuration of the light source according to the third embodiment, the width in the Z direction of the groove portion GP is the same as the width of the groove portion according to the second embodiment. However, similarly to the second embodiment, the groove portion GP may be configured to pass through in the Z direction.

As described above, in the backlight device according to the third embodiment, the substrate PC on which the light emitting diodes LED are mounted, is fixed to the side wall surface of the groove portion GP that is formed on the back surface side of the light guide plate LG. In this way, the light guide plate LG and the light source are integrated into a single unit. Thus, also in the backlight device according to the third embodiment, the same effect as the second embodiment described above can be obtained.

### Fourth Embodiment

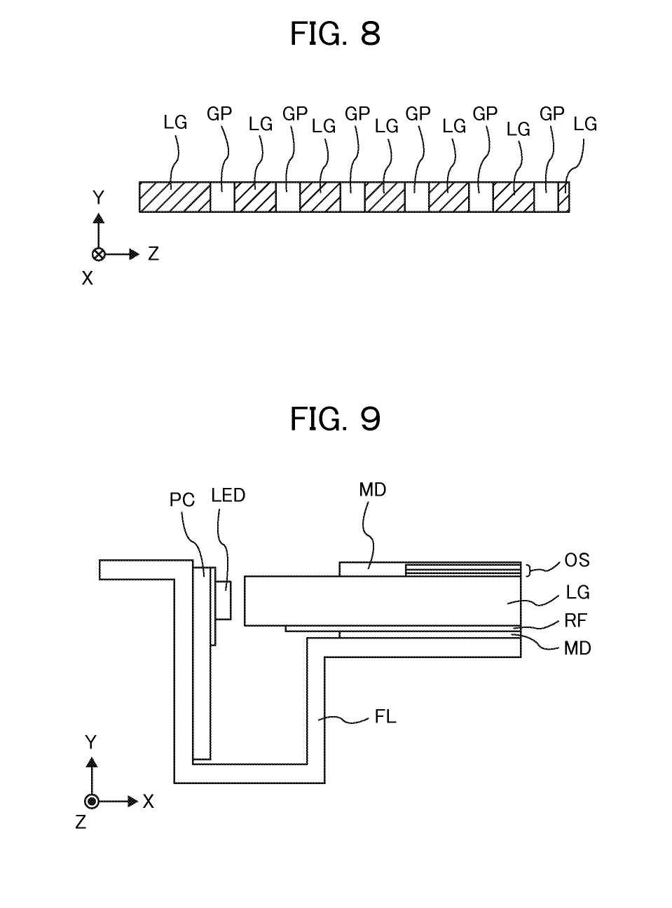

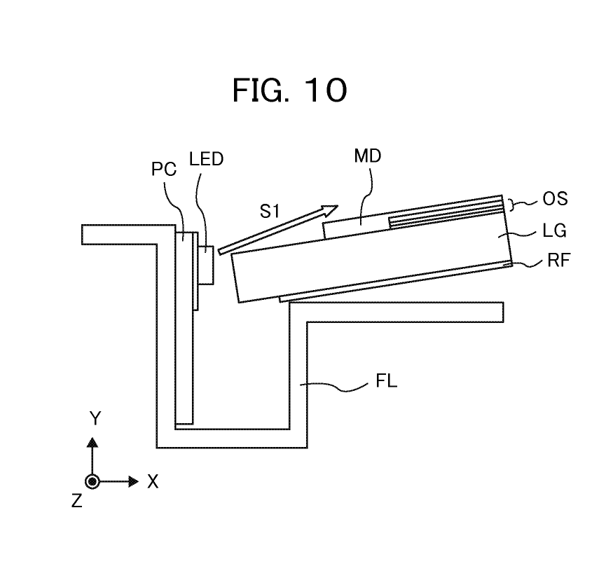

FIG. 7 is a top view showing the general configuration of the backlight device in a liquid crystal display device according to a fourth embodiment of the present invention. FIG. 8 is a side view showing the general configuration of the backlight device in the liquid crystal display device according to the fourth embodiment of the present invention. FIGS. 7 and 8 are enlarged views of the part on which the light emitting diode is mounted. Note that the outer shape of the light emitting diode LED according to the fourth embodiment is similar to that in the second and third embodiments. More specifically, the base part on which the light emitting part is placed and the lens part are the same size. However, similarly to the light emitting diode LED according to the first embodiment, the base part and the lens part may be different in size.

As shown in FIG. 7, in the backlight device according to the fourth embodiment, multiple groove portions GP are formed so as to pass through from the surface to the back surface of the light guide plate LG along the side surface of the light guide plate LG. At this time, the side surface of the light guide plate LG is also opened. The light emitting diodes LED are placed in each of the groove portions GP. The attachment of the light emitting diode LED in the backlight device according to the fourth embodiment with the configuration described above, as shown in the enlarged view B′ in FIG. 7, the substrate PC is bonded to the side surface, and only the light emitting diode LED mounted on the substrate PC is placed in the groove portion GP. At this time, similarly to the first embodiment, the bottom of each groove portion GP, namely, the surface parallel to the side surface of the light guide plate LG is the light incident surface. With this configuration, only the light emitting diodes LED arranged in parallel on the surface of the substrate PC extending in the Z direction are placed in the groove portions GP. In this way, the light source is fixed to the side surface of the light guide plate LG.

Particularly, in the configuration of the light guide plate LG according to the fourth embodiment, as shown in FIG. 8, the concave groove portions GP are formed in the X direction (the side of the irradiation area) from the side surface of the light guide plate LG. The part on which the groove portion GP is not formed is convex and the groove portion GP is concave in the side surface on which the light source is mounted. Thus, the concave and convex portions are alternately arranged in the Z direction. In other words, as shown in FIG. 4, in the configuration of another light guide plate LG according to the first embodiment, of the side walls forming the groove portion GP, a pair of side walls is not formed along the surface and back surface of the light guide plate LG.

As described above, also in the backlight device according to the fourth embodiment, the groove portion GP is formed on the side surface of the light guide plate LG, and only the light emitting diode LED mounted on the substrate PC is placed in the groove portion GP. Thus, the same effect as that of the first embodiment can be obtained. Particularly, in the backlight device according to the fourth embodiment, the side walls are not formed on the surface and back surface of the light guide plate LG. Thus, it is possible to return the light emitted from the opening on the back surface side to the outside, to the side of the light emitting diode LED, for example, by extending the reflecting RF provided on the back surface side of the light guide plate LG to the groove portion GP. As a result, the incident efficiency of the light from the light emitting diode LED can be improved.

Further, in the backlight device according to the fourth embodiment, the side walls are not formed on the surface and back surface of the light guide plate LG. This makes it easy to take air into the groove portion GP from outside and thus improves the cooling effect of the light emitting diode LED. As a result, the light emission efficiency of the light emitting diode LED can be improved.

Further, in the backlight device according to the fourth embodiment, the side walls of the groove portion GP are not formed along the surface and back surface of the light guide plate LG. Thus, by appropriately selecting the fixing material such as double-sided tape to fix the substrate PC to the side surface of the light guide plate LG, it is possible to obtain a remarkable effect of increasing the range of the light emitting diode LED to follow the warpage of the light guide plate LG.

Further, in the backlight device according to the fourth embodiment, it does not require to form a pair of facing side walls of the groove portion GP, namely, the side wall along the surface of the light guide LG and the side wall along the back surface of the light guide plate LG. The groove portion GP can also be formed by punching the light guide plate LG from the surface to the back surface. This can lead to a remarkable effect of improving the production efficiency of the light guide plate LG.

Note that in the configuration of the backlight device according to the first and fourth embodiments of the present invention, the substrate PC of aluminum substrate is attached along the side surface of the light guide plate LG. Thus, the back side of the subtract PC is attached to the frame member FL to conduct heat generated by the light emitting diode LED, so that the heat generated by the light emitting diode LED is conduced to the frame member FL through the substrate PC and is released.

Further, in the backlight device according to the first to fourth embodiments of the present invention, the substrate PC is attached to the groove portion GP of the light guide plate LG with no warpage. However, the present invention is not limited to this configuration. For example, in the case of the light guide plate LG in which a warpage occurs in the assembly process, the substrate PC is attached to the groove portion GP in such a way that the substrate PC is curved along the warpage of the light guide plate LG and is attached to the groove portion GP. Then, the light guide plate LG on which the light source is mounted is placed on the top of the reflecting plate RF. In this case, the light source is attached along the warpage occurring in the formation of the light guide plate LG. Thus, it is possible to eliminate the stress that is applied to the light guide plate LG and the substrate PC in the assembly process of the backlight device. In addition, the substrate PC is fixed according to the specific warpage occurring in the formation of the light guide plate LG. Thus, an allowance can be made for deformation by the adhesive material, such as double-sided tape, when the light guide plate LG is more warped due to the heat generated by the light emitting diode LED during use, and the like. This can lead to a remarkable effect of improving the performance of the light source against the warpage of the light guide plate LG.

Further, in the backlight device according to the first to fourth embodiments of the present invention, an air gap is formed around the light emitting diode LED. In other words, the light emitted from the light emitting diode LED is incident on the light guide plate LG through the air layer. However, the present invention is not limited to this configuration. For example, it is possible that the gap between the light emitting diode LED and the groove portion GP is filled with a transparent resin.

Although the invention made by the present inventors has been specifically described based on the embodiments of the present invention, the present invention is not limited to the specific embodiments, and various changes and modifications can be made without departing from the scope of the present invention.

What is claimed is:

1. A liquid crystal display device comprising:
a liquid crystal display panel formed by a pair of transparent substrates facing each other with a liquid crystal layer therebetween; and
a backlight device mounted on a back surface side of the light crystal display panel,
wherein the backlight device includes:
a light source in which a plurality of light emitting elements are arranged in parallel on a surface of a substrate; and
a light guide plate for converting light from the light source that is provided in the periphery of the light guide plate, into planar light (backlight beam) and emitting the planar light,
wherein the light guide plate has a groove portion being concave along the periphery,
wherein at least the light emitting elements are inserted into the groove portion to integrate the light guide plate and the light source into a single unit, and
wherein a bottom of the groove portion formed at a position closer to an irradiation area of the planar light than a side surface of the light guide plate, or/and a side wall surface of the groove portion is/are incident surface(s) of the light from the light emitting elements.

2. The liquid crystal display device according to claim 1,
wherein the groove portion is formed on the side surface of the light guide plate such that a side wall of the groove portion is formed along the periphery of the side surface, and
wherein an emission side of the light emitting elements are provided so as to face the bottom of the groove portion.

3. The liquid crystal display device according to claim 2, wherein the substrate on which the light emitting elements are arranged in parallel is fixed to the periphery of the groove portion.

4. The liquid crystal display device according to claim 3,
wherein the groove portion is a single concave groove portion formed along the longitudinal direction of the side surface of the light guide plate, and
wherein the light emitting elements are placed in the groove portion.

5. The liquid crystal display device according to claim 3,
wherein the groove portion includes two or more concave groove portions arranged in parallel along the longitudinal direction of the side surface of the light guide plate, and
wherein at least one or more of the light emitting elements are placed in the groove portion.

6. The liquid crystal display device according to claim 1,
wherein the groove portion includes two or more concave groove portions arranged in parallel along the longitudinal direction of the side surface of the light guide plate, and
wherein at least one or more of the light emitting elements are placed in the groove portion.

7. The liquid crystal display device according to claim 3,
wherein the groove portion includes concave portions arranged in parallel in the longitudinal direction of the side surface of the light guide plate, each concave portion having an opening formed on the side surface side of the light guide plate to pass through in the thickness direction of the light guide plate, and
wherein at least one or more of the light emitting elements are placed in each groove portion being concave.

8. The liquid crystal display device according to claim 1,
wherein the groove portion includes a concave portion which is opened on a surface or back surface of the light guide plate, the opening being formed in an area outside the irradiation area of the planar light, and
wherein an emission side of the light emitting elements is provided so as to face the side wall surface close to the irradiation area of the planar light, of the side wall surfaces of the groove portion.

9. The liquid crystal display device according to claim 8, wherein the substrate on which the light emitting elements are arranged in parallel is fixed to a side wall surface facing the side wall surface close to the irradiation area of the planar light.

10. The liquid crystal display device according to claim 1, wherein the substrate is a flexible wiring substrate in which signal lines of conductive thin film are formed on a surface of resin as a base material.
